(19) United States
(12) Patent Application Publication
(10) Pub. No.: US 2006/0157972 A1
(43) Pub. Date: Jul. 20, 2006

(54) Inside reducing pipe bushing

(76) Inventor: Douglas Catton, San Diego, CA (US)

Correspondence Address: WEIDE & MILLER, LTD., 7251 W. LAKE MEAD BLVD., SUITE 530, LAS VEGAS, NV, 89128, US

(21) Appl. No.: 11/205,840

(22) Filed: Aug. 17, 2005

Related U.S. Application Data
(60) Provisional application No. 60/640,856, filed on Jan. 3, 2005.

(51) Int. Cl. F16L 55/00

(52) U.S. Cl. 285/148.23

(57) ABSTRACT

A reducing bushing comprises a body having a first end and a second end, a passage there through, and a flange extending outwardly at the first end. The body is configured to accept over an exterior thereof, at the second end, a first pipe member. The body is configured to accept within the passage, at the first end, a second pipe member. The reducing bushing is effective in connecting pipes of differing sizes, in an overlapping and space-saving configuration.

### RELATED APPLICATION DATA

This application claims priority to U.S. Provisional Application Ser. No. 60/640,856, filed Jan. 21, 2005.

### FIELD OF THE INVENTION

The present invention relates to methods and devices for connecting pipes of different sizes.

### BACKGROUND OF THE INVENTION

PVC/ABS and similar “plastic” piping is commonly used in a wide variety of applications, including irrigation, pool and indoor plumbing. Unlike metal piping, which is generally threaded or welded together, this plastic piping can be bonded together using adhesive. For example, referring to FIG. 1, two sections of plastic pipe P1, P2 of the same size can be connected by inserting their ends into opposing sides of a larger “slip fit” connector C. The ends of the pipe are bonded to the slip fit connector using adhesive.

A particular problem arises, however, when one attempts to connect such pipe members having different sizes. Normally, such a connection requires use of a number of connector members. For example, referring to FIG. 2, a slip-fit connector C1 may be located over the end of the larger pipe P1. An end of a reducing fitting R may then be slipped into the other end of the slip-fit connector C1. A second connector C2 may then be used to connect a second end of the reducing fitting R with the smaller pipe P2. In this configuration, three connectors and four bonds are necessary to join the pipes. This has the significant detriment of increasing the time necessary to form the connection (by locating and preparing the various components and connecting them) and increasing the risk of failure, such as leakage, of the system. More importantly, however, this configuration takes up a great deal of space. As illustrated, the ends of the pipes P1,P2 must be separated by a great distance to accommodate all of the connectors there between.

In great number of environments, such as underground pool piping, working space may be significantly limited. In such instances, there is often insufficient space to permit the insertion of the multiple components necessary to join the two different pipes. In addition, in many instances, there is also insufficient space to locate a fitting over a pipe end, such as where a pipe is embedded in concrete.

An improved method and device for joining pipes of different sizes is desired.

### SUMMARY OF THE INVENTION

The invention is a reducing bushing. The reducing bushing is particular useful in coupling or joining pipe members, and particularly, pipe members of different sizes. The reducing bushing can be used for a variety of other purposes, including as a plug.

In one embodiment, the reducing bushing comprises a body having a first end and a second end. The body defines a passage there through from the first end to the second end. In a preferred embodiment, the body includes a flange extending outwardly at the first end thereof, the body thus having an exterior and an interior. The body at the exterior at the first end has a first diameter defined by the flange, which diameter exceeds a second diameter of the body at the exterior at the second end.

The body is preferably configured to accept over the exterior thereof at the second end a first pipe member, and is configured to accept within the passage at the first end a second pipe member.

The reducing bushing may be used to connect a variety of pipe members, including pipe sections, pipe fittings and other members such as gauges, sprinkler heads, risers and the like. The reducing bushing is particularly useful in connecting two pipes or pipe members having different sizes. For example, the reducing bushing may be utilized to connect a two (2) inch pipe and a one (1) inch pipe.

In a preferred embodiment, the body of the reducing bushing is constructed of PVC, ABS or a similar material and is configured to accept the pipe members in slip-fit relationship. The pipe member may be affixed to the reducing bushing by adhesive. When configured to accept the pipe members in a slip-fit relationship, the portions of the body which accept the pipe members are preferably smooth. The reducing bushing can, however, include threads for engaging one or more pipe members in a threading or other connecting relationship.

One aspect of the invention is a method of using the reducing bushing to connect two pipe members. In accordance with method, a first pipe member is extended over the exterior of the reducing bushing at one end. The second pipe member is inserted into the passage of the reducing bushing at its other end.

In a preferred embodiment, an end of the first pipe member is extended over the second end of the reducing bushing until it reaches the flange at the first end of the body. In such a configuration, at least a portion of the body is located between the first and second pipe members, which are then arranged in overlapping fashion.

The reducing bushing, by its configuration of fitting inside a first pipe member an accepting therein a second pipe member, enables the two pipe member to be connected in a minimal amount of space and with a minimal number of components.

Further objects, features, and advantages of the present invention over the prior art will become apparent from the detailed description of the drawings which follows, when considered with the attached figures.

### DESCRIPTION OF THE DRAWINGS

FIG. 1 illustrates a slip-fit connection for pipes of the same size in accordance with the prior art;

FIG. 2 illustrates a multiple connector connection for pipes of different sizes in accordance with the prior art;

FIG. 3 is a perspective end view of an embodiment reducing bushing in accordance with the present invention;

FIG. 4 is a cross-sectional view of the reducing bushing illustrated in FIG. 3;

FIG. 5 is a cross-sectional view of the reducing bushing illustrated in FIG. 3 for use in connecting first and second pipe members; and

FIG. 6 is a cross-sectional view of the reducing bushing and pipe members illustrated in FIG. 5, as assembled.

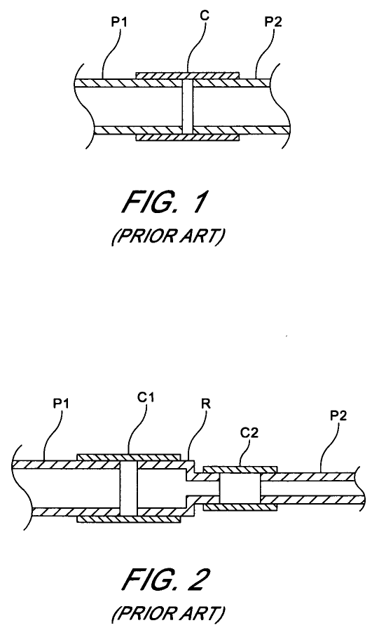

### DETAILED DESCRIPTION OF THE INVENTION

The invention is a reducing bushing and a method and device for joining pipes or similar elements of different sizes. In the following description, numerous specific details are set forth in order to provide a more thorough description of the present invention. It will be apparent, however, to one skilled in the art, that the present invention may be practiced without these specific details. In other instances, well-known features have not been described in detail so as not to obscure the invention.

In general, the invention is a bushing which is particularly useful in joining pipes or pipe/plumbing members or elements. The bushing of the invention is referred to as a “reducing” bushing since, in its preferred embodiment, the bushing can be used to connect two pipe members, one of which is larger than the other. As detailed below, however, the bushing may have a variety of configurations and uses.

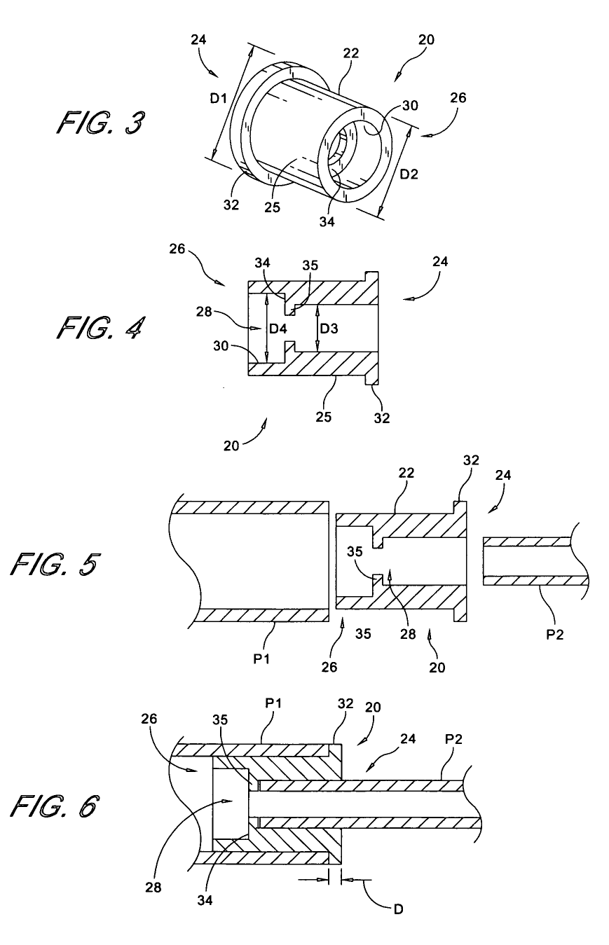

One embodiment of a reducing bushing 20 of the invention will be described with reference to FIGS. 3 and 4. The reducing bushing 20 comprises a body 22. The body 22, and thus the bushing 20, as a first end 24 and an opposing second end 26. The body 22 has an exterior or exterior surface 25. As the body 22 defines a passage or aperture 28 there through from the first end 24 to the second end 26, the body 22 also has an interior or interior surface 30.

In a preferred embodiment, the body 22 is generally circular in cross-sectional shape (when the cross-section is taken perpendicular to a line passing through the first and second ends 24,26 thereof). Thus, the body 22 has a somewhat cylindrical solid body design.

Referring to FIG. 3, the body 22 has a first outer diameter D1 at the first end 24, and a second outer diameter D2 at the second end 26. In a preferred embodiment, the outer diameter D1 at the first end 24 is defined by a flange 32. The flange 32 preferably defines an area of increased outer diameter D1 of the body 22, thus causing the first outer diameter D1 at the first end 24 to exceed the second outer diameter D2 at the second end 26. As illustrated, in a preferred embodiment, the flange 32 generally extends outwardly over only a short distance or portion of the body 22 from the first towards the second end 24,26. In this configuration, the diameter of the outside of the body 22 remains relatively constant over most of the body 22, only increasing at the first end 24 thereof at the location of the flange 32.

The passage 28 also has a size. In a preferred embodiment where the passage 28 is generally circular in cross-sectional shaped, this size is a diameter. As illustrated in FIG. 4, the passage 28 has a first diameter D3 at the first end 24 of the body 22, and a second diameter D4 at the second end 26 of the body 22. In a preferred embodiment, the second diameter D4 is larger than the first diameter D3, such that a step 34 is defined by the body 22 in the passage 28.

In addition, in a preferred embodiment, a stop 35 is provided for limiting the insertion distance of a pipe element, as detailed below. In one embodiment, the stop 35 extends radially inward at the location of the step 34. Preferably, the stop 35 extends inwardly by a distance which is approximately equal to the thickness of a wall of a pipe element inserted into the passage 28, as also detailed below. It will be appreciated that the stop 35 could be located elsewhere in the passage 28, and could have other sizes and shapes.

In one embodiment, the inner surface 30 at the first end 24 of the body 22, and the outer surface 25 at the second end 26 of the body 22 are generally smooth for mating with respective pipe elements in a slip-fit configuration, as detailed below. In a preferred embodiment, the body 22 is of a solid construction. Preferably, the body 22 is constructed from PVC/ABS or similar material. In one embodiment, the body 22 may constructed in a molding process.

As detailed below, the reducing bushing 20 is preferably configured to connect two pipe members or elements of different sizes. Preferably, the bushing 20 is configured to accept one pipe element at the exterior thereof and one pipe element at the interior thereof. As such, the body 22 is preferably sized to fit the desired pipe members.

Additional details of the reducing bushing 20 will now be described along with one method of using the reducing bushing 20. As illustrated in FIG. 5, the reducing bushing 20 may be configured to connect two pipes of two different sizes. A first pipe P1 has a first diameter and a second pipe P2 has a second diameter. As illustrated, the diameters of these pipes vary, thus preventing their direct connection, or their connection using a “slip-fit” type coupling or similar member (as is possible when the pipes are of the same size, as in the example illustrated in FIG. 1).

In accordance with the invention, the reducing bushing 20 is configured to be located within the interior of the larger pipe P1 and to accept therein the smaller pipe P2. In particular, the pipe P1 has an inside and an outside diameter (the differences between the diameters comprising a wall thickness of the pipe). The diameter D2 of the reducing bushing 20 at its second end 26 is slightly smaller than the inside diameter of the pipe P1, whereby the pipe P1 will slip over the second end 26 of the reducing bushing 20.

Likewise, the second pipe P2 has an inside diameter and an outside diameter. The first diameter D3 of the passage 28 is slightly larger than the outer diameter of the pipe P2. In this manner, the second pipe P2 can be extended into the passage 28 from the first end 24 of the reducing bushing 20.

FIG. 6 illustrates the pipes P1 and P2 as coupled by the reducing bushing 20. In a preferred embodiment, the first pipe P1 is extended over the second end 26 of the reducing bushing 20 towards the first end 24. Preferably, the distance by which the pipe P1 may be extended over the reducing bushing 20 is limited by the flange 32. Thus, a free end of the pipe P1 may be located adjacent the flange 32. The pipe P1 and the reducing bushing 20 may be coupled to one another with adhesive. Adhesives utilized to join PVC and ABS pipe elements are well known.

At the same time, the second pipe P2 is located within the passage 28 defined by the body 22 of the reducing bushing 20. In one embodiment, the second pipe P2 is associated with the reducing bushing 20 so that a free end of the second pipe P2 terminates at the stop 35. In this manner, only a single “reduction” location is defined along the flow path through the pipes (rather than a first offset at the step 34, wherein the passage reduces in size, and then a later second offset due to the wall thickness of the pipe P2, which reductions, if offset, may increase turbulence and result in a greater impediment to flow).

As with the second pipe P2, the first pipe P1 is preferably connected to the reducing bushing 20, such as with adhesive.

Additional and other aspects of the invention will now be described. As indicated, the reducing bushing is useful in connecting two pipe members. These pipe members may comprise pipe or pipe sections, as illustrated in FIG. 6. The pipe or plumbing members or elements may be of a variety of other types, however, such as an elbow, a gauge, a riser, a sprinkler head, a “T” or a variety of other fittings, or other members/elements now known or later developed.

As indicated, the passage defined by the reducing bushing preferably has a first diameter and a second diameter. However, the passage may have a substantially continuous diameter there through (such as a continuous diameter D3 as illustrated in FIG. 4) or could have a reducing diameter (i.e. instead of having one step defining the reduction in diameter, multiple steps or a tapered wall might be utilized).

In a preferred embodiment, the reducing bushing is configured to mate with other elements in a slip-fit configuration. As such, the diameters of the passage 28 and the body 22 at the exterior surface 30, may be tapered or reduce slightly in order to interference fit with a mating pipe member. The reducing bushing may be configured in other fashions. For example, the passage 28 at the first end 24 of the body 22 may be threaded in order to accept a threaded pipe element (whether in male or female configuration), such as a threaded riser, gauge or the like.

Where the reducing bushing is configured to mate with pipe members or elements in a slip-fit configuration, the size of the bushing is, as detailed above, selected to mate with those elements. For example, if the inside diameter of the first pipe P1 is one (1) inch, then the exterior diameter D2 of the body 22 at the second end 24 is preferably just slightly less than one (1) inch. Likewise, if the outside diameter of the second pipe P2 is 0.5 inches, then the diameter D3 of the passage 28 is preferably just slightly more than 0.5 inches.

In a preferred embodiment, the width of the flange is no more than about 5-10% of the total length of the reducing bushing, in order to maximize the pipe member overlap distance which is permitted and minimize the distance by which the reducing bushing extends beyond the end of a pipe member connected thereto.

In one embodiment, the reducing bushing may be used for purposes other than connecting pipes of different sizes. For example, the reducing bushing could be fit within a pipe, and then have a gauge connected thereto (such as by threading engagement with the interior passage thereof).

In one embodiment, the reducing bushing could be used as a plug. For example, the reducing bushing could be located in an end of a pipe and a plug could then be located within the passage of the reducing bushing, thus closing the passage there through. In this manner, the pipe end is effectively plugged. In such a configuration, the reducing bushing has particular applicability where the pipe end or other plumbing member will not accept a fitting there over. For example, a pipe may terminate with its end encased or encircled in concrete. In that situation, the reducing bushing/plug conveniently fits within the pipe end. Another piping element, such as a plug, may then be connected to the reducing bushing, thus effecting connection to the original pipe end. Alternatively, if the reducing bushing is itself configured as a plug, it can be directly inserted into the pipe end and plug that pipe end.

Various aspects of the reducing bushing of the invention will now be appreciated. First, the reducing bushing is useful in connecting pipe members or elements of different sizes. Most advantageously, the reducing bushing of the present invention is space saving. In accordance with the design of the reducing bushing, a first pipe member is located over the exterior of the bushing and a second pipe member is accepted into the bushing, whereby the pipe members overlap one another. Referring to FIG. 6, in such an embodiment, two pipe members can be joined with only a small portion D of the bushing exposed between the pipe members. The reducing bushing of the invention also permits to pipe members to be connected using a single element or member. The reducing bushing of the invention thus not only requires much less space than previous means for coupling or joining pipe members of different sizes, but requires only a single component whereas previous methods generally required that multiple components be connected to one another in sequence between the pipe members.

Another advantage of the reducing bushing is that all mountings are “inside” another element, thus minimizing the total dimension of the coupling. In particular, because the reducing bushing fits inside one pipe element and another pipe element fits within the bushing, the total exterior dimension of the coupling is not greater than the first pipe element. This is an advantage over traditional couplings where one or more connectors are slipped over the pipe elements to form a connection. In the case where a pipe is confined, such as when encased in concrete or extending directly against other pipes or structures, the reducing bushing can be used by direct insertion into the pipe, whereas traditional connectors may not fit over the pipe due to interference with the adjacent concrete.

It will be understood that the above described arrangements of apparatus and the method there from are merely illustrative of applications of the principles of this invention and many other embodiments and modifications may be made without departing from the spirit and scope of the invention as defined in the claims.

What is claimed is:

1. A reducing bushing configured to connect a first pipe member and a second pipe member, comprising:
a body having a first end and a second end, said body defining a passage there through from said first end to said second end, said body including a flange extending outwardly at said first end thereof, said body having an exterior and an interior, said body at said exterior at said first end having a first diameter defined by said flange which exceeds a second diameter of said body at said exterior at said second end, said body configured to accept over said exterior thereof at said second end said first pipe member and said body configured to accept within said passage at said first end said second pipe member, whereby when connected to said first and second pipe members, at least a portion of said body is located between said first pipe member and said second pipe member.

2. The reducing bushing in accordance with claim 1 wherein said passage has a first portion having a first diameter and a second portion having a second diameter.

3. The reducing bushing in accordance with claim 2 wherein said first portion extends inwardly from said first end and said second portion extends inwardly from said second end of said body.

4. The reducing bushing in accordance with claim 3 wherein said second diameter exceeds said first diameter.

5. The reducing bushing in accordance with claim 4 wherein a step is defined in said passage at the intersection of said first and second portions of said passage.

6. The reducing bushing in accordance with claim 1 wherein said exterior surface of said body at said second end is generally smooth for accepting said first pipe member in slip-fit relationship there over.

7. A method of connecting a first pipe member having an inner diameter and a second pipe member having an outer diameter, said inner and outer diameters being different from one another, comprising:
providing a reducing coupling comprising a body having a first end and a second end, an exterior and defining a passage there through defining an interior;
extending said first pipe member over said exterior of said reducing coupling from said first end towards said second end;
extending said second pipe member into said passage through said reducing coupling at said second end of said body; and
affixing said first and second pipe members to said body.

8. The method in accordance with claim 7 wherein said body includes an outwardly extending flange at said second end of said body and including the step of extending said first pipe member over said exterior of said reducing coupling until an end of said pipe member abuts said flange.

9. The method in accordance with claim 7 wherein said passage has a first portion having a first diameter and a second portion with a second diameter, said first diameter being greater than said second diameter, said first and second portions divided by a step defined by said body.

10. The method in accordance with claim 9 wherein a stop extends inwardly at said step and said second pipe member is extended into said passage until an end thereof abuts said stop.

11. The method in accordance with claim 7 wherein said step of affixing comprises adhering said first and second pipe members to said body.

12. The method in accordance with claim 7 wherein said first and second pipe members comprise pipes comprising a generally circular wall defining a central passage.

13. The method in accordance with claim 7 wherein said first and second pipe members are selected from the group consisting of: a pipe, a gauge, a riser, and a pipe fitting.
